(19) United States
(12) Patent Application Publication
(10) Pub. No.: US 2014/0170459 A1
(43) Pub. Date: Jun. 19, 2014

(54) Liquid Electrolyte for Increasing Capacity and Cycling Retention of Lithium Sulfur Battery

(71) Applicants: Donghai Wang, State College, PA (US); Shuru Chen, State College, PA (US); Fang Dai, State College, PA (US)

(72) Inventors: Donghai Wang, State College, PA (US); Shuru Chen, State College, PA (US); Fang Dai, State College, PA (US)

(73) Assignee: THE PENN STATE RESEARCH FOUNDATION, University Park, PA (US)

(21) Appl. No.: 14/108,094

(22) Filed: Dec. 16, 2013

Related U.S. Application Data
(60) Provisional application No. 61/737,606, filed on Dec. 14, 2012.

(51) Int. Cl. H01M 4/58; H01M 10/0525; H01M 10/056

(52) U.S. Cl. CPC H01M 4/58; H01M 10/056; H01M 10/0525
USPC 429/105

(57) ABSTRACT

We provide a liquid electrolyte for a lithium-sulfur battery. Electrolytes of the invention may include a protecting additive; a lithium salt (in addition to LiNO₃, if that is selected as the protecting additive); at least one electrolyte solvent; and a dissolved electrochemically active material comprising sulfur. In one embodiment an electrolyte includes 0.1-2 M of one or more of LiPF₆, LiBF₄, LiAsF₆, LiClO₄, LiCF₃SO₃, LiN(CF₃SO₂)₂, 0.1-1 M LiNO₃, at least one nonaqueous solvent; and dissolved electrochemically active material comprising sulfur in the form of at least one of a soluble lithium polysulfide and/or organodisulfide compounds, which is used in a lithium-sulfur cell and a battery having a plurality of lithium-sulfur cells.

### CROSS-REFERENCE TO RELATED APPLICATIONS

This application claims priority to U.S. Provisional Patent Application No. 61/737,606, filed on Dec. 14, 2012. That application is incorporated by reference herein.

### STATEMENT REGARDING FEDERALLY SPONSORED RESEARCH OR DEVELOPMENT

Portions of this invention were made using funds from the Assistant Secretary for Energy Efficiency and Renewable Energy, Office of Vehicle Technologies of the U.S. Department of Energy under Contract No. DE-EE0005475. The United States government may have certain rights in this invention.

### BACKGROUND OF THE INVENTION

1. Field of the Invention

Embodiments of the invention relate to electrolytes for use with lithium-sulfur batteries.

2. Description of the Related Art

Many consider rechargeable lithium-ion batteries to be favorable energy storage devices for both existing and future upcoming hybrid electric-vehicles (HEV) and full electric vehicles (EV). Unfortunately, many lithium-ion batteries are unsatisfactory for one or more of a number of reasons. For example, they may lack a desired high capacity, or they may lack a long cycle lifetime. In many cases these drawbacks are the result of use of a cathode that is inadequate for the task of high capacity, long cycle duty. Common cathode materials include cobalt oxide, manganese oxide, mixed oxides with nickel, iron phosphate, and vanadium oxide.

After decades of intensive development, lithium ion (Li-ion) batteries are still incapable of meeting the energy density requirements of emerging applications such as electric vehicles. The exploration of new electrochemistry and new materials is thus necessary for the creation of high-energy battery systems. The rechargeable lithium-sulfur (Li—S) battery is a promising candidate because sulfur has a high theoretical specific capacity of 1675 mAh/g and a high specific energy of 2600 Wh/kg.

Many solutions have been proposed for increasing the conductivity of the sulfur. Typically these solutions involve incorporating the sulfur into cathodes in conjunction with carbon or a conducting polymer. Unfortunately, neither the carbon nor the conducting polymer, taken alone, is able to ameliorate the polysulfide shuttle effect.

Extensive attempts have been devoted to improving the electrochemical performance of sulfur electrodes. These include attempts at electrolyte modification, use of additives, and anode protection. Recently, considerable attention has focused on immobilizing the polysulfides within the cathode by addition of metal oxides, such as Mg_{0.6}Ni_{0.4}O, V₂O₅, SiO₂, and Al₂O₃. Performance of the sulfur cathodes obtained in these attempts was largely suboptimal because the approaches relied on simple, inhomogeneous mixtures of metal oxides and sulfur.

The Li—S system operates by conversion of sulfur through a multistep redox reaction, forming different lithium sulfide products (LiₛSₓ, 1≦x≦8). Ether-based electrolytes are normally used in Li—S batteries because of their ability to dissolve insulating polysulfides and thus improve their reaction kinetics. However, this dissolution can also lead to loss of active material from the cathode, causing capacity fading, and to a shuttle phenomenon that leads to poor coulombic efficiency. The formation of insoluble, insulating Li₂S on the surface of both the cathode and the lithium anode also contributes to poor sulfur utilization and capacity fading because of its poor reversibility.

Considerable effort has been devoted to engineering carbon/sulfur (C/S) composites that are capable of trapping soluble polysulfides by physical or chemical adsorption or of enabling the reversible reaction of Li₂S at the positive electrode. Electrolyte additives, e.g. LiNO₃ and P₂S₅, were reported to passivate lithium metal and suppress the redox shuttle of polysulfides, resulting in unproved coulombic efficiency. P₂S₅ was also reported to promote the dissolution and reversible reaction of Li₂S. Nevertheless, none of these approaches are sufficient to fully address the dissolution of polysulfides and the accumulation of Li₂S.

Since the dissolution of polysulfides is inevitable, Li—S liquid batteries that directly use dissolved polysulfides as a catholyte, as reported decades ago, have been re-considered recently; their capacity and cyclability are still not satisfactory. Alternately, increasing sulfur loading in the cathode might be expected to increase the cell capacity and mitigate the effect of losing active mass to dissolution; however, even lower sulfur utilization and faster capacity fading have usually been reported, possibly due to the poorer conductivity and formation of more insoluble products in the cathode.

### BRIEF SUMMARY OF THE INVENTION

Embodiments presented herein provide a new approach for a high-performance lithium-sulfur battery by combining conventional C/S cathode with liquid electrolyte containing dissolved electrochemically active material. The dissolved electrochemically active material includes sulfur in the form of at least one of a soluble lithium polysulfide and/or an organodisulfide compound or compounds having the formula RSSR′, where R and R′ are the same or different, and where they may be C1-C6 alkyl, straight or branched (for example, dimethyl disulfide (DMDS), diethyl disulfide (DEDS), dipropyl disulfide (DPDS), and isopropyl disulfide (IPDS)). Through use of a sufficient concentration of an active sulfur species and amount of electrolyte, the unfavorable formation of insoluble Li₂S is avoided and the capacity, cyclability, and rate capability of the cell are drastically improved.

### DETAILED DESCRIPTION OF THE FIGURES

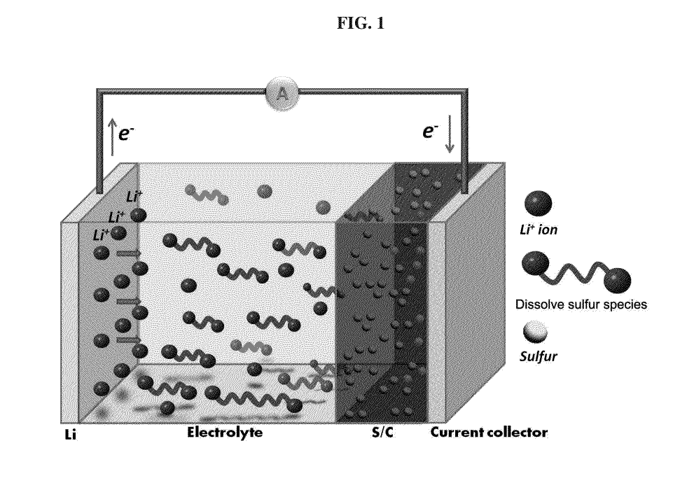

FIG. 1 shows a schematic configuration of a Li—S cell with active sulfur species containing electrolyte, sulfur-carbon cathode, and lithium anode.

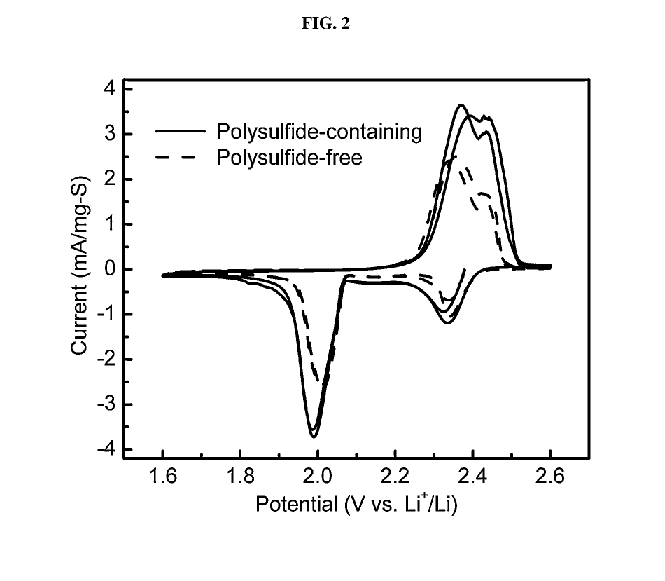

FIG. 2 compares the CV curves in 10 μL of polysulfide-free and polysulfide-containing (Li₂S₉, [S]=2 M) electrolyte at 0.1 mV s⁻¹ scanning rate.

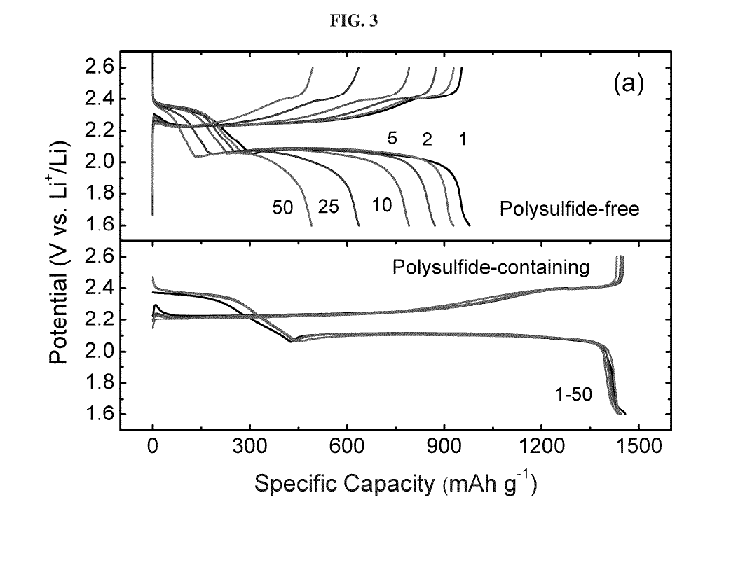

FIG. 3 compares voltage profiles at C/3 rate in 10 μL of polysulfide-free and polysulfide-containing (Li₂S₉, [S]=2 M) electrolyte between 1.6 V and 2.6 V.

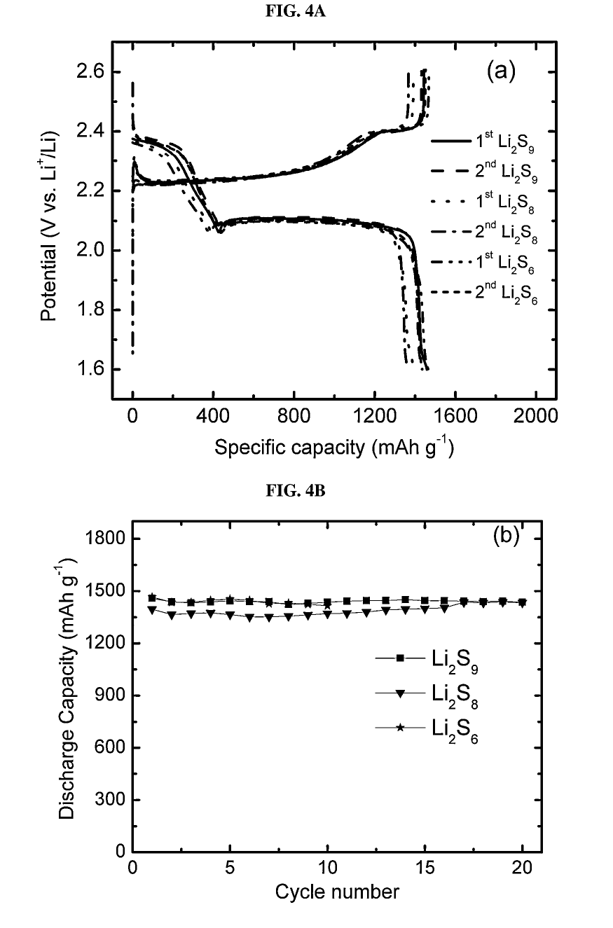

FIG. 4A shows voltage profiles at C/3 rate in 10 μL of polysulfides-containing electrolytes with different average polysulfide chain lengths and sulfur concentration [S]=2 M between 1.6 V and 2.6 V.

FIG. 4B shows cycling performance at C/3 rate in 10 μL of polysulfides-containing electrolytes with different average polysulfide chain lengths and sulfur concentration [S]=2 M between 1.6 V and 2.6 V.

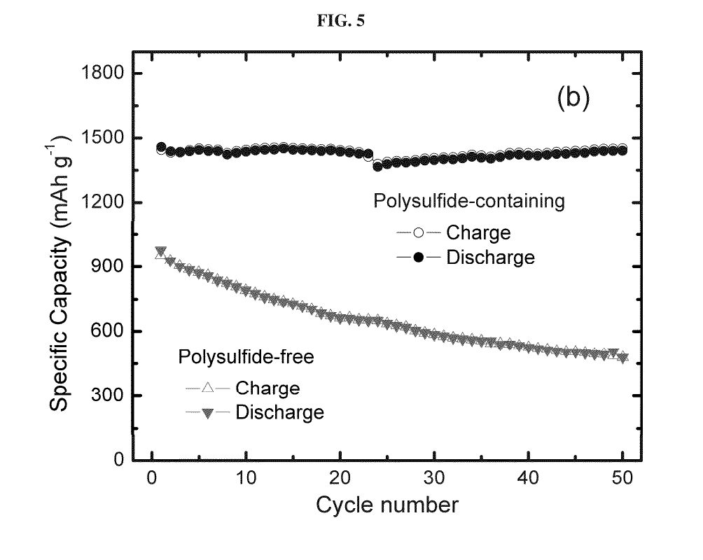

FIG. 5 compares the cycling performance at C/3 rate in 10 μL of polysulfide-free and polysulfide-containing (Li₂S₉, [S]=2 M) electrolyte between 1.6 V and 2.6 V.

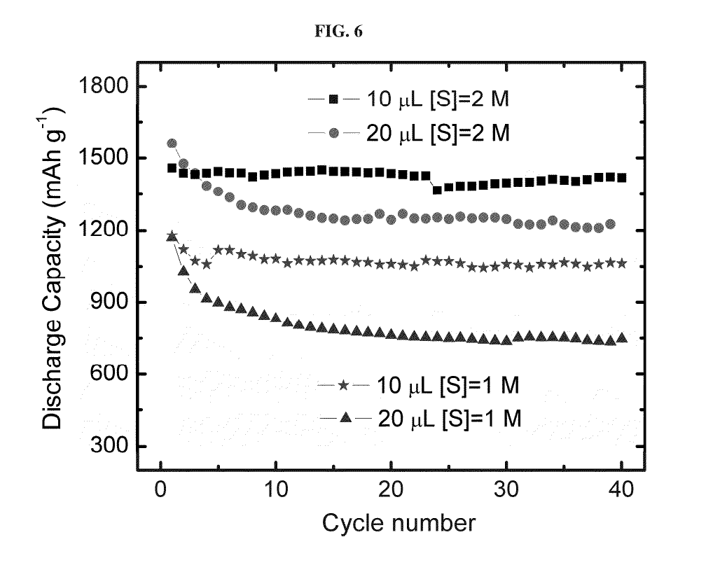

FIG. 6 shows the cycling performance at C/3 rate in different amount of electrolytes with various sulfur concentrations.

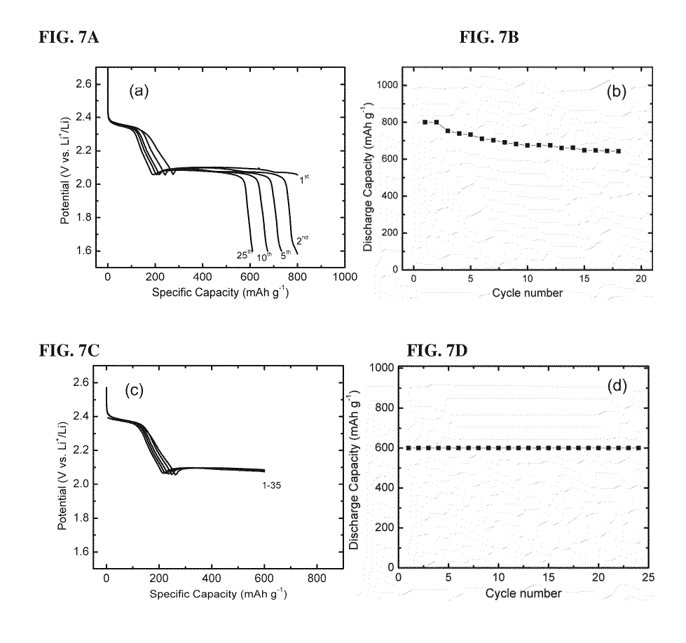

FIG. 7A shows voltage profiles at C/10 rate in 10 μL of polysulfides-free electrolyte discharged with a cut-off voltage at 1.6 V and a cut-off discharge capacity of 800 mAh/g.

FIG. 7B shows cycling performance at C/10 rate in 10 μL of polysulfides-free electrolyte discharged with a cut-off voltage at 1.6 V and a cut-off discharge capacity of 800 mAh/g.

FIG. 7C shows voltage profiles a C/10 rate in 10 μL of polysulfides-free electrolyte discharged with a cut-off voltage at 1.6 V and a cut-off discharge capacity of 600 mAh/g.

FIG. 7D shows cycling performance at C/10 rate in 10 μL of polysulfides-free electrolyte discharged with a cut-off voltage at 1.6 V and a cut-off discharge capacity of 600 mAh/g.

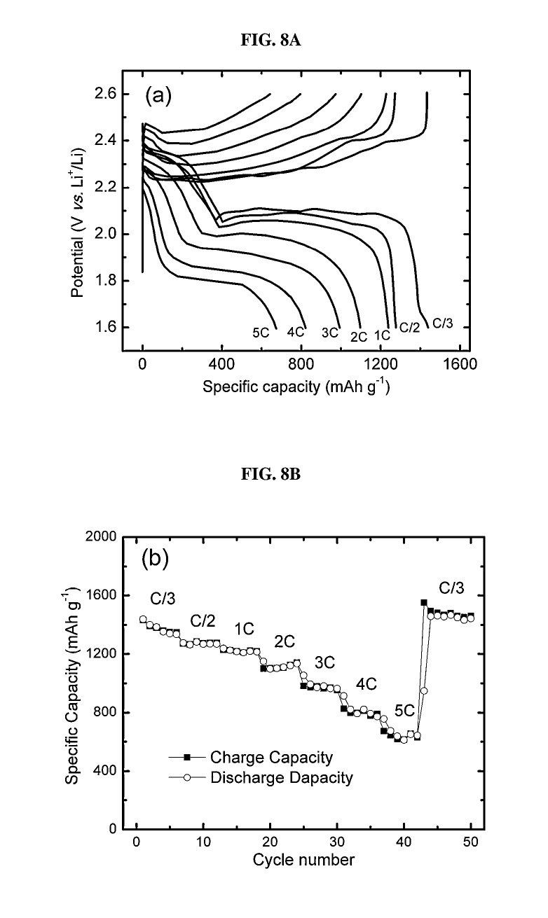

FIG. 8A shows voltage profiles at various rates in 10 μL polysulfide-containing electrolyte with [S]=2 M.

FIG. 8B shows rate capability in 10 μL polysulfide-containing electrolyte with [S]=2 M.

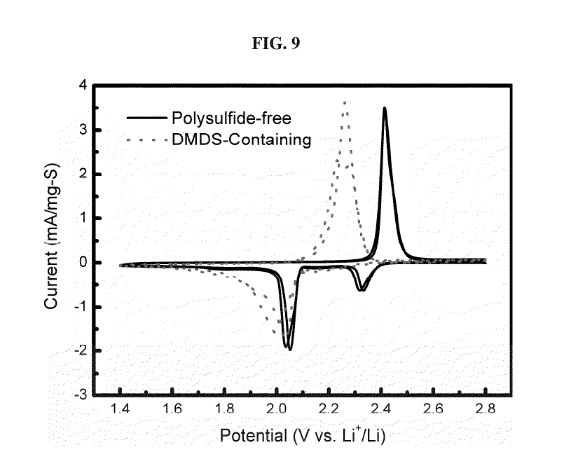

FIG. 9 compares the CV curves in 10 μL of polysulfide-free electrolyte and 1 M LiTFSI (lithium bis(trifluoromethanesulfonyl) imide)+0.1 M LiNO₃ in DME/DOL/DADS (that is, dimethoxyethane/dioxolane/dimethyldisulfide) (25 wt %: 25 wt %: 50 wt %) at 0.05 mV s⁻¹ scanning rate.

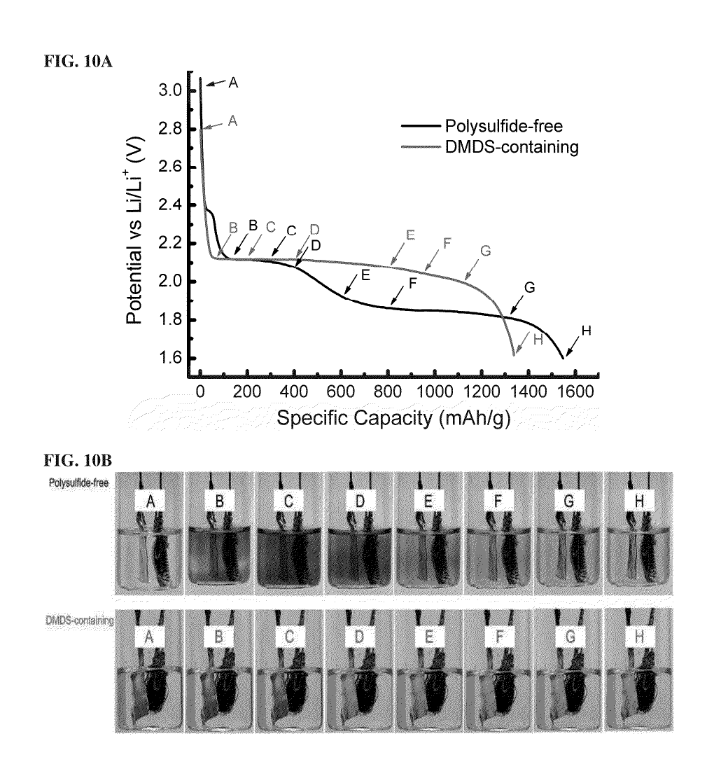

FIG. 10A compares voltage profiles for the initial discharge process at a current rate of 50 mA/g-S in bulk cells with 6 ml of of polysuifide-free electrolyte and 1 M LiTFSI+0.1 M LiNO₃ in DME/DOL/DMDS (25 wt %: 25 wt %: 50 wt %).

FIG. 10B shows the changing of color in the polysulfide-free electrolyte and 1 M LiTFSI+0.1 M LiNO₃ in DME/DOL/DMDS (25 wt %: 25 wt %: 50 wt %) at different discharge capacities.

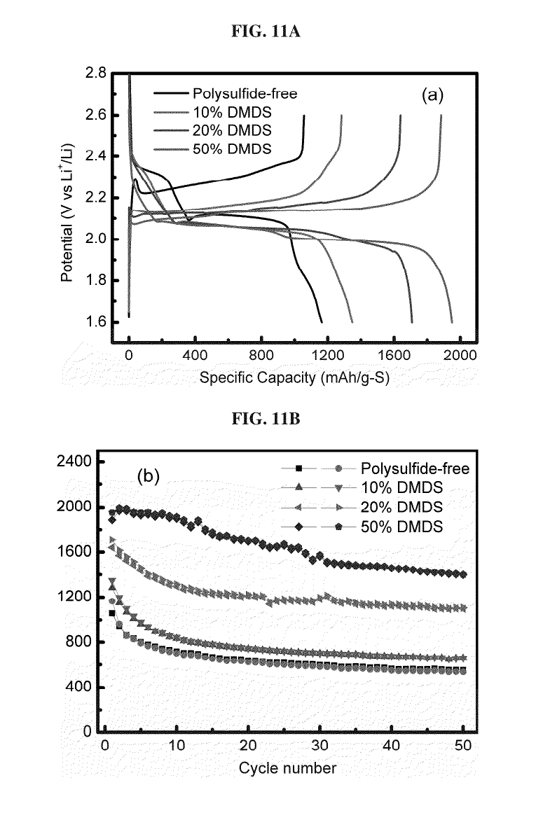

FIG. 11A compares voltage profiles at C/10 in 10 μL of polysulfide-free electrolyte and 1 M LiTFSI+0.1 M LiNO₃ in DME/DOL/DMDS with different weight ratios of solvents at 45 wt %: 45 wt %: 10 wt %, 40 wt %: 40 wt %: 20 wt %, and 25 wt %: 25 wt %: 50 wt %.

FIG. 11B compares cycling performance at C/10 in 10 μL of polysulfide-free electrolyte and 1 M LiTFSI+0.1 M LINO₃ in DME/DOL/DMDS with different weight ratios of solvents at 45 wt %: 45 wt %: 10 wt %, 40 wt %: 40 wt %: 20 wt %, and 25 wt %: 25 wt %: 50 wt %.

### DETAILED DESCRIPTION OF THE INVENTION

### I. ELECTROLYTES

Embodiments of the invention provide a liquid electrolyte for a lithium-sulfur battery. Electrolytes of the invention include a protecting additive; a lithium salt in addition to the protective additive; at least one electrolyte solvent; and a dissolved electrochemically active material comprising sulfur. The protective additive may be, for example, LiNO₃, P₂S₅, or fluorinated ether. Use of LiNO3 is reported, for example, in U.S. Pat. No. 7,553,590, which is incorporated by reference herein. Use of P₂S₅ as a protectingadditive is reported, for example, in Lin, Z., et al., “Phosphorous Pentasulfide as a Novell Additive for High-Performance Lithium-Sulfur Batteries,” Adv. Func. Mat. 2013: 23(8), 1064-69, and fluorinated ether is reported in “Improved Performance of Lithium-Sulfur Batter with Fluorinated Electrolyte,” Electrochem. Comm., December 2013: 37, 96-99, both of which are incorporated by reference herein. The dissolved electrochemically active material is in the form of at least one of a soluble lithium polysulfide (Li₂Sₓ) with between about 1 to 10 molar sulfur atoms (i.e. Li₂S, Li₂S₂, Li₂S₃, Li₂S₄, Li₂S₅, Li₂S₆, Li₂S₇, Li₂S₈, Li₂S₉, Li₂S₁₀, or mixtures of those) and/or about one or more organodisulfide compounds (for example, dimethyl disulfide (DMDS), diethyl disulfide (DEDS), dipropyl disulfide (DPDS), and isopropyl disulfide (IPDS)). These ingredients are discussed in more detail below. Various embodiments may comprise, consist of, or consist essentially of these components.

A. Protecting Additive

Embodiments of the invention typically include a protecting additive. This additive tends to increase cycling stability and coulombic efficiency in the electrolyte. In typical embodiments the protecting additive is present in the electrolyte in a concentration between 0.1 and 1M, 0.1 and 0.5 M, and 0.5 and 1 M. Ideally the protective additive will be at least 99.999% pure prior to addition to the electrolyte, though a certain level of purity is not required unless otherwise stated in the claims. The protective additive may be, for example, LiNO₃, P₂S₅, or fluorinated ether.

B. Lithium Salt

Embodiments of the invention will include at least one lithium salt in addition to the LiNO₃. Suitable lithium salts include, for example, but are not limited to, LiPF₆, LiBF₄, LiAsF₆, LiClO₄, LiCF₃SO₃, and LiN(CF₃SO₂)₂ (also referred to as “LiTFSI”). These lithium salts dissolve in the electrolyte and help form a charge transfer medium.

These lithium salts are typically included in the electrolyte, either alone or in combination, in concentrations between 0.1-2 M. Other embodiments include one or more lithium salts in concentrations between 0.1-1 M, 0.1-0.5 M, 0.5-2 M, 1-2 M, or 1.5-2 M.

C. Solvent

Electrolytes of the invention further include one or more nonaqueous solvents. These solvents may be ethers (both cyclic and/or acyclic), sulfones (for example, ethyl methyl sulfone), or combinations of those. Suitable solvents include, for example, but are not limited to dioxolane, dimethoxyethane, and combinations of those. When in combination the solvents may be included in a ratio of 1:1, 1:2, 2:1, or other amounts. Preferably the solvent will include less than 20 ppm water.

D. Dissolved Electrochemically Active Material Including Sulfur

Embodiments of the invention include at least one dissolved electrochemically active sulfur material that is dissolved in the electrolyte. The material may be, for example, a soluble lithium polysulfide (Li₂Sₓ). The lithium polysulfide may have between about 1 to 10 molar sulfur atoms (i.e. Li₂S, Li₂S₂, Li₂S₃, Li₂S₄, Li₂S₅, Li₂S₆, Li₂S₇, Li₂S₈, Li₂S₉, Li₂S₁₀, or mixtures of those).

In other embodiments the material is one or more organodisulfide compound. Preferably the organodisulfide is a liquid at room temperature. For example, suitable compounds include dimethyl disulfide (DMDS) and diethyl disulfide (DEDS). Suitable organodisulfides have the formula RSSR′, where R and R′ may be the same or different, and where they may be C1-C6 alkyl, straight or branched. By “C1-C6 alkyl” it is meant a hydrocarbon including one to six carbons, saturated or unsaturated, along with a sufficient number of hydrogen sufficient to render the moiety neutral when attached to a sulfur.

Although not wishing to be bound by theory, the applicant believes that in the alkyl disulfide-based electrolyte, sulfur reacts chemically with RSSR′ to form alkyl polysulfide RSₓR′, where x is between 3-17. (mainly RS₃R) intermediates, which then could receive 2 e⁻ and be reversibly reduced to alkyl thiolate (RS⁻) and disulfide anion (RSS⁻) during discharge process without the unfavorable formation of lithium polysulfide and insoluble Li₂S₂/Li₂S.

The dissolved electrochemically active sulfur material is typically present in an amount in the form of at least one of a soluble lithium polysulfide (Li₂Sₓ) with between about 0.1 to 4 mole/L of sulfur atoms. For RSSR′, with a weight percentage of from 1.0% to 50%, the concentration is between about 0.2 to 1M.

E. Preparation of Electrolyte

Electrolytes may be prepared by dissolving the protecting additive and additional lithium salt(s) in a solvent. Lithium sulfide and stoichiometic amount of sulfur and/or organodisulfides are then added until the desired concentration of each is reached. The solution is stirred, then allowed to sit until the reaction that creates the electrode has run to completion or near-completion. The time and temperature used for the mixture depend on the concentration of polysulfide. If the concentration is low, it can dissolve and react completely in several minutes. If the concentration is high, one may need to heat to about 75° C. and stir for several hours in a glovebox. Mixture of organodisulfides is not accomplished due to their imiscibility in the electrolyte.

In the examples given below, a reference electrolyte referred to as a “non-sulfur containing” electrolyte including 0.1 M LiTFSI+0.2 M LiNO3 in DOL/DME (1:1, v:v) is prepared by dissolving required amounts. The required amount will depend on the amount of electrolyte that is being prepared; for example, preparing 1 L of electrolyte would use 0.1M LiTFSI and 0.2M LiNO₃ in DOL/DME (1:1, v:v). To form polysulfide-containing electrolytes of the embodiments of the invention, stoichiometric amounts of elemental sulfur and Li₂S are added to form polysulfide-containing electrolytes of different sulfur concentration ([S]) and different average polysulfide chain length. When adding stoichiometric amounts of elemental sulfur Li₂S, one can calculate the xin Li₂Sx, which is the average chain length. In the electrolyte there are typically a mixture of different Li₂Sx.

The solution is stirred for 6 hours at 75° C. followed by 48 hours at room temperature to complete the reaction and dissolution and form dark red polysulfide-containing electrolytes of moderate viscosity. Less stirring and lower heat may also suffice. Organodisulfides for the examples discussed herein were purchased from Sigma and directly added as additives in the reference electrolyte to form organodisulfide-containing electrolytes.

### II. EXAMPLES

Embodiments of the invention are better understood by characterization of their abilities and comparison with various electrolytes known in the prior art. To that end a number of examples are presented below.

A. Preparation of Sulfur Cathodes

Embodiments of the invention do not require sulfur cathodes prepared by a particular method. However, for illustrative purposes only, and to explain how cathodes are prepared for the following examples, the following method is offered. Sulfur cathodes are prepared by ball milling 50 wt % elemental sulfur, 40 wt % Super P carbon black, and 10 wt % PVDF binder in NMP solution at 300 rpm for 3 hours to make a slurry, followed by spreading the slurry on aluminium foil using a common doctor-blade coating method. After drying at 55° C. under vacuum overnight, the electrodes are cut into circular pieces of 1.13 cm2 (12 mm diameter) with sulfur loading of about 0.6 mg cm-2 and incorporated into CR-2016 coin-type cells with a precisely controlled amount of either reference or sulfur species-containing electrolyte. All the electrolyte preparation and cell assembly steps are performed in an Ar-filled glove box with O₂ and H₂O less than 1 ppm. Of course, those of skill in the art will recognize that additional methods may be used.

B. Experimental Conditions

The coin-type cells can be galvanostatically cycled on battery testing systems (Neware BTS-5V1 mA or Arbin BT-2000) under room temperature. In one instance, the cutoff potentials for charge and discharge were set at 2.6 V and 1.6 V vs. Li+/Li, respectively, and cyclic voltammetry (CV) scanning was carried out on a CHI660 system using coin-type cells and with a scanning rate of 0.1 mV s⁻¹.

C. Representative Battery Cell

FIG. 1 shows a schematic configuration of a Li—S cell with soluble active sulfur species-containing electrolyte, sulfur-carbon cathode, and lithium anode. The optimization of the concentration of the active sulfur species and the amount of electrolyte avoids the unfavorable formation of insoluble Li₂S, thereby dramatically improving the capacity, cyclability, and rate of capability of the cell.

D. Electrolyte Preparation

In one embodiment, polysulfide-containing electrolytes with the desired sulfur concentration ([S]) and average polysulfide chain length are prepared by chemically reacting stoichiometric amounts of sulfur and Li₂S in a polysulfide-free electrolyte of 0.1 M lithium bis(trifluoromethanesulfonyl)imide (LiTFSI)+0.2 M LiNO₃ in dioxolane (DOL)/dimethoxyethane (DME) (1:1, v:v). One or more nonaqueous solvents may be selected from the group consisting of acyclic ethers, cyclic ethers, and sulfones can also be used as electrolyte solvents.

Electrolytes of embodiments of the invention may also be made, for example, by in-situ reaction of stoichimetric amounts of sulfur and lithium metal in the polysulfide-free electrolyte of the preceding paragraph. Cathodes containing 50 wt % sulfur are prepared by ball milling, and no novel porous carbon/sulfur composites are used. The resulting cathodes have an average loading of 0.6 mg S/cm² with an area of 1.13 cm².

The cyclic voltammetry (CV) curves in 10 μL of polysulfide-free and polysulfide-containing (Li₂S₉, [S]=2 M) electrolyte at 0.1 mV s⁻¹ scanning rate are depicted in FIG. 2. The profiles show two main cathodic peaks at around 2.3 and 2.0 V, which are related to the change from elemental sulfur to the higher-order lithium polysulfides (Li₂Sₓx≧4), and the reduction of higher-order lithium polysulfides to lower-order lithium polysulfides (Li₂Sₓ, x≧4), respectively. Subsequent anodic scans show one main oxidation peak at 2.35 and another shoulder peak at 2.45 V, indicating the conversion from lower-order lithium polysulfides to elemental sulfur. All the peak currents in the polysulfide-containing electrolyte are much higher than in the polysulfide-free electrolyte, indicating the extra capacity contribution from Li₂S₉ in the electrolyte,

As shown in FIG. 3, the discharge/charge profiles of cells in 10 μL of polysulfide-free and polysulfide-containing (Li₂S₉, [S]=2 M) electrolyte at a rate of C/3 (1C=1680 mA g⁻¹ of S in the cathode) have two voltage plateaus: a higher one at 2.4 V and a lower one at 2.0 V, which are consistent with the CV results. The initial discharge capacity in the polysulfide-free electrode is 980 mAh g⁻¹ and the initial discharge capacities in the polysulfide-containing electrolytes are 1460 mAh g⁻¹ (based on S in the cathode only), and 750 mAh g⁻¹ (based on total S in both cathode and electrolyte). Discharge capacities decrease gradually with cycling in the polysulfide-free electrolyte but show little change in the polysulfide-containing electrolyte. Similar voltage profiles and cycling performance occur when using other soluble lithium polysulfides such as Li₂S₈ and Li₂S₆ with [S] equal to 2 M under the same testing condition, as shown in FIGS. 4A and 4B.

FIG. 4A shows voltage profiles at C/3 rate in 10 μL of polysulfides-containing electrolytes with different average polysulfide chain lengths and sulfur concentration [S]=2 M between 1.6 V and 2.6 V. FIG. 4B shows cycling performance at C/3 rate in 10 μL of polysulfides-containing electrolytes with different average polysulfide chain lengths and sulfur concentration [S]=2 M between 1.6 V and 2.6 V. The performance is largely independent of polysulfide chain length, likely because the reduction mechanism for the first reduction step of sulfur and polysulfides may be the same for all polysulfides with a chain length of at least 6.

FIG. 5 shows the cycling performance at C/3 rate in 10 μL of polysulfide-free and polysulfide-containing (Li₂S₉, [S]=2 M) electrolyte between 1.6 V and 2.6 V. The coulombic efficiency for both cells is close to 100%, owing to the protection of lithium metal by LiNO₃ additive. Capacity retention is dramatically improved by using 10 μL of polysulfide-containing electrolyte with [S]=2 M. The discharge capacity is stabilized at c.a. 1460 mAh g⁻¹ (based on S in the cathode only), and 750 mAh g⁻¹ (based on total S in both cathode and electrolyte) in this electrolyte, while with polysulfide-free electrolyte the capacity decreases to below 480 mAh g⁻¹ after only 50 cycles. Although with polysulfide-containing electrolyte the capacity is around 750 mAh g⁻¹ of total S, the cell capacity is almost doubled in comparison to cells with polysulfide-free electrolyte.

The concentration of sulfur species and the amount of electrolyte show significant effects on the performance of Li—S batteries, independent of polysulfide chain length. FIG. 6 shows the cycling performance at C/3 rate in different amount of electrolytes with various sulfur concentrations. Discharge capacities are stable for the first 40 cycles as the amount of polysulfide-containing electrolyte is kept at 10 μL for each cell. The stable discharge capacity creases from 1050 mAh g⁻¹ (based on S in the cathode only) and 700 mAh g⁻¹ (based on total S in both cathode and electrolyte) to 1450 mAh g⁻¹ (based on S in the cathode only) and 750 mAh g⁻¹ (based on total S in both cathode and electrolyte) when [S] increases from 1 M to 2 M, indicating the extra capacity provided by adding more polysulfides.

When the amount of electrolyte is doubled, the mass of S added to each cell is also doubled, but the initial discharge capacity hardly changes. Capacity drops fairly quickly in the first 10 cycles and stabilizes at 760 mAh g⁻¹ (based on S in the cathode only) and 500 mAh g⁻¹ (based on total S in both cathode and electrolyte) when [5] is 1 M, and at and 1250 mAh g⁻¹ (based on S in the cathode only) and 650 mAh g⁻¹ (based on total S in both cathode and electrolyte) when [5] is 2 M.

All cells tested in polysulfide-containing electrolyte stabilized within about 10 cycles with capacities below 836 mAh g⁻¹ based on total S from cathode and electrolyte (50% utilization of S with capacity of 1672 mAh/g), meaning there is less than 1e⁻ per S transferred during cycling. The ultimate product during discharge is primarily slightly soluble Li₂S₂ and some higher-order polysulfide such as Li₂S₄. Conductive surfaces in the positive electrode may be passivated by significant precipitation of Li₂S₂during discharge, induced by the polysulfides added to the electrolyte, leading to huge polarization and causing the cell to reach the cut-off voltage before much Li₂S₂ can be further reduced to insoluble Li₂S. This is confirmed by the sharp drop of the discharge curves at the end of discharge in FIG. 3, as a slope at the end of discharge is attributed to conversion from Li₂S₂ to Li₂S, which is kinetically slow and normally suffers high polarization.

Although not wishing to be bound by theory, the applicant suggests that avoiding the irreversible formation of Li₂S, the cell can be reversibly cycled between elemental sulfur and Li₂S₂ through multiple soluble polysulfides. These reactions are dominated by the interfacial charge transfer and are highly reversible and kinetically fast. The depth of discharge (DOD) of cells with polysulfide-free electrolyte was controlled to avoid formation of Li₂S. Cyclability was improved when an appropriate capacity cut-off 600 mAh g⁻¹ was selected, but cell capacity decreased as shown in FIG. 7A-7D.

FIG. 7A shows voltage profiles at C/10 rate in 10 μL of polysulfides-free electrolyte discharged with a cut-off voltage at 1.6 V and a cut-off discharge capacity of 800 mAh/g. FIG. 7B shows cycling performance at C/10 rate in 10 μL of polysulfides-free electrolyte discharged with a cut-off voltage at 1.6 V and a cut-off discharge capacity of 800 mAh/g. FIG. 7C shows voltage profiles at C/10 rate in 10 μL of polysulfides-free electrolyte discharged with a cut-off voltage at 1.6 V and a cut-off discharge capacity of 600 mAh/g. FIG. 7D shows cycling performance at C/10 rate in 10 μL of polysulfides-free electrolyte discharged with a cut-off voltage at 1.6 V and a cut-off discharge capacity of 600 mAh/g. In FIG. 7A-7D, the cells stopped discharging at whichever cut-off was met first. Cycling performance was greatly improved when a cut-off discharge capacity (as set on the testing equipment) of 600 mAh g⁻¹ was selected.

The rate performance of Li—S batteries using the polysulfide-containing electrolyte was tested. When the rate is increased to 5 C (8.4 A g⁻¹), the sample still delivered a capacity of more than 600 mAh g⁻¹ (based on S in the cathode only) and 310 mAh g⁻¹ (based on total S in both cathode and electrolyte) with a coulombic efficiency of close to 100%, and relatively low polarization with a second voltage plateau at ˜1.8 V, indicating remarkable high-rate capability as shown in FIG. 8A-8B. FIG. 8A shows voltage profiles at various rates in 10 μL polysulfide-containing electrolyte with [S]=2 M. FIG. 8B shows rate capability in 10 μL polysulfide-containing electrolyte with [S]=2 M. The discharge capacity can be recovered when the ate is returned to C/3, showing great reversibility.

In this case the electrolyte shows only one cathodic peak at around 2.0 V in CV curves (FIG. 9), which is related to the reduction of alkyl polysulfide RSₓR. Subsequent anodic scans show also only one oxidation peak at 2.3, which is lower than 2.45 V for polysulfide-free electrolyte, indicating better reversibility of the discharge-charge process in alkyl disulfide-based electrolyte.

To show the different discharge-charge mechanism of sulfur cathode in polysulfide-free and alkyl disulfide-based electrolyte, we took photos at different discharge capacities for the initial discharge in both electrolytes, thereby monitoring this process. The results are shown in FIG. 10A and FIG. 10B. We could observe the change of color from colorless and transparent at the beginning to red, then green and finally yellow in polysulfide-free electrolyte, indicating t generation of different Li₂Sₓ (x from 8-2). However, the color of alkyl disulfide-based electrolyte almost do not change during the discharge process, suggesting a totally different discharge mechanism of sulfur cathode in this electrolyte system.

FIG. 11 shows the cycling performance at C/10 rate in 10 μL of organodisulfide-containing (dimethyl disulfide, DMDS) electrolytes with different weight ratio of DMDS between 1.6 V and 2.6 V. Both the capacity and capacity retention can also be improved for the cells with increasing concentration of DMDS from 10 wt % to 50 wt % in the electrolyte. We did not further increase the concentration of DMDS because of the lower conductivity of the electrolyte, which may greatly affect the rate performance of the cell.

Those skilled in the art will understand that the various embodiments presented herein may be varied by those of skill in the art who have the advantage of reviewing this disclosure. Those variations are included within the spirit and the scope of the various embodiments of the invention.

We claim:

1. An electrolyte comprising:
a protecting additive;
a lithium salt;
at least one nonaqueous solvent; and
a dissolved electrochemically active material, wherein said dissolved electrochemically active material is selected from soluble lithium sulfide, soluble lithium disulfide, soluble lithium polysulfide, an organodisulfide, and combinations thereof.

2. The electrolyte of claim 1, wherein the lithium salt is selected from the group consisting of LiPF₆, LiBF₄, LiAsF₆, LiClO₄, LiCF₃SO₃, and LiN(CF₃SO₂)₂.

3. The electrolyte of claim 1, wherein the at least one nonaqueous solvent is selected from the group consisting of an acyclic ether, a cyclic ether, a sulfone, and combinations thereof.

4. The electrolyte of claim 1, wherein the at least one nonaqueous solvent is selected from the group consisting of dioxolane, dimethoxyethane, and combinations thereof.

5. The electrolyte of claim 1, wherein be dissolved electrochemically active material comprises LixS, and wherein 1≦x≦10.

6. The electrolyte of claim 1, wherein the dissolved electrochemically active material comprises an organodisulfide having the formula RSSR′, wherein R and R′ may be the same or different, and wherein R and R′ may be C1-C6 alkyl, straight or branched.

7. The electrolyte of claim 6, wherein the dissolved electrochemically active material is selected from the group consisting of group consisting of methyl disulfide (DMDS), diethyl disulfide (DEDS), dipropyl disulfide (DPDS), and isopropyl disulfide (IPDS).

8. The electrolyte of claim 1, wherein the protecting additive, the lithium salt, and the dissolved electrochemically active material are present in the following concentrations:
the protecting additive is present in a concentration between 0.1 and 1 M;
the lithium salt is present in a concentration between 0.1 and 2 M; and
the dissolved electrochemically active aerial is present in a concentration between 0.1 to 4 mole/L of sulfur atoms.

9. The electrolyte of claim 1, wherein the protecting additive is selected from the group consisting of LiNO₃, P₂S₅, and fluorinated ether.

10. A lithium-sulfur cell comprising:
a sulfur-carbon cathode;
a lithium anode; and
an electrolyte, said electrolyte comprising
a protecting additive;
a second lithium salt;
at least one nonaqueous solvent; and
a dissolved electrochemically active material, wherein said dissolved electrochemically active material is selected from soluble lithium sulfide, soluble lithium disulfide, soluble lithium polysulfide, an organodisulfide, and combinations thereof.

11. The lithium-sulfur cell of claim 1.0, wherein the lithium salt is selected from the group consisting of LiPF₆, LiBF₄, LiAsF₆, LiClO₄, LiCF₃SO₃, and LiN(CF₃SO₂)₂.

12. The lithium-sulfur cell of claim 10, wherein the at least one nonaqueous solvent is selected from the group consisting of an acyclic ether, a cyclic ether, a sulfone, and combinations thereof.

13. The lithium-sulfur cell of claim 10, wherein the at least one nonaqueous solvent is selected from the group consisting of dioxolane, dimethoxyethane, and combinations thereof.

14. The lithium-sulfur cell of claim 10, wherein the dissolved electrochemically active material comprises LixS, and wherein 1≦x≦10.

15. The lithium-sulfur cell of claim 10, wherein the dissolved electrochemically active material comprises an organodisulfide having the formula RSSR′, wherein R and R′ may be the same or different, and wherein R and R′ may be C1-C6 alkyl, straight or branched.

16. The lithium-sulfur cell of claim 10, wherein the dissolved electrochemically active material is selected from the group consisting of dimethyl disulfide (DMDS), diethyl disulfide (DEDS), dipropyl disulfide (DPDS), and isopropyl disulfide (IPDS).

17. The lithium-sulfur cell of claim 10, wherein the first lithium salt, the second lithium salt, and the dissolved electrochemically active material are present in the following concentrations:
the protecting additive is present in a concentration between 0.1 and 1 M;
the lithium salt s present in a concentration between 0.1 and 2 M; and
the dissolved electrochemically active material is present in a concentration between 0.1 to 4 mole/L, of sulfur atoms.

18. The lithium-sulfur cell of claim 10, wherein the protecting additive is selected from the group consisting of LiNO₃, P₂S₅, and fluorinated ether.

19. A battery comprising a plurality of lithium-sulfur cells of claim 9.
